(19) United States
(12) Patent Application Publication
(10) Pub. No.: US 2025/0205920 A1
(43) Pub. Date: Jun. 26, 2025

(54) LOG SUPPORT ASSEMBLY FOR A SAWMILL

(71) Applicant: WOODLAND MILLS INC., Port Perry (CA)

(72) Inventors: Joshua J. MALCOLM, Port Perry (CA); Neil K. BRAMLEY, Port Perry (CA); Jeffrey F. DOHERTY, Peterborough (CA)

(73) Assignee: WOODLAND MILLS INC., Port Perry, ON (CA)

(21) Appl. No.: 18/849,653

(22) PCT Filed: Mar. 6, 2023
(86) PCT No.: PCT/CA2023/000005

§ 371 Date: Sep. 23, 2024

(30) Foreign Application Priority Data
Mar. 23, 2022 (CA) 3153144

(51) Int. Cl. B27B 29/04

(52) U.S. Cl. CPC B27B 29/04

(57) ABSTRACT

A log support assembly for a sawmill. The log support assembly has an elongate log support member with at least one aperture in its side wall, a holder for releasably holding the elongate log support member, a passageway in the holder for slidably receiving the elongate log support member, and a projection extending into the passageway. The projection is sized and shaped to releasably engage the at least one aperture. The passageway is sized and shaped to allow the elongate log support member to be tilted between a locked position with the projection engaging the at least one aperture, and an unlocked position with the projection disengaged from the at least one aperture. The locked position prevents the elongate log support member to be lowered relative to the holder. The unlocked position permits the elongate log support member to be raised or lowered relative to the holder.

### FIELD OF THE INVENTION

The present invention relates generally to sawmills. More particularly, the present invention relates to log support assemblies for portable sawmills.

### BACKGROUND OF THE INVENTION

A conventional sawmill typically utilizes a relatively large circular saw blade mounted along the path of travel of a log placed on a suitable moving bed with a drive mechanism for advancing the log against the blade. Typically, such sawmills are permanent installations located centrally to established logging operations and operated on a more or less continuous basis. Such sawmills normally are built only to service large tracts of forests capable of supporting a regular commercial mill. However, there are many situations where a commercial sawmill is not economically feasible or practical. For example, owners of relatively small tracts of forested land may wish to produce finished or semi-finished lumber from their own logs either for their own use or for resale. Even with large tracts of forested land it may be desirable in some instances to cut logs into finished and semi-finished products before transporting the wood out of the forest. In either of such cases it is desirable that a portable sawmill be available so that it may be moved about easily from one cutting location to another. U.S. Pat. No. 4,334,669 discloses an example of one such portable sawmill.

FIGS. 1 and 2 depict another example of a prior art portable sawmill 10 disclosed in U.S. Pat. No. 11,130,253. As can be seen, the portable sawmill has a bed 12 for supporting a log (not shown), and a carriage 14 for carrying a saw 16, such as for example a band saw. The bed 12 includes a pair of parallel rails 18, and several log bunks 20 arranged between the rails 18, for support the log. The carriage 14 is movable along the rails 18 on wheels 22. With the saw 16 operating, moving the carriage 14 along the rails 18 over the log allows a saw blade 24 of the saw 16 to cut the log.

Furthermore, it is known to provide a log support system to hold the log in position on the bed 12 to keep it from moving as the log is being cut with the saw 16, since any such movement would affect the quality of a board (not shown) being cut from the log. For example, movement of the log on the bed 12 as the log is being cut with the saw blade 24 could cause undesirable grooves, changes in thickness, and other inconsistencies to the profile of the board, potentially resulting in the board being unsuitable for its intended purpose.

Such log support systems are known to include log supports 26 (also known as log rests), and log dogs 28. An example of a prior art log support system is shown in FIGS. 1 and 2. As can be seen, the system allows a user to clamp the log in place on the bed 12 between the log supports 26 and the log dogs 28. The log supports 26 function as the back-stop against which the log dogs 28 exert force, thereby clamping the log. Typical log support systems provide means for raising and lowering the heights of both the log supports 26 and the log dogs 28. Typical log dogs 28 employ a cam-operated clamp that squeezes the log.

U.S. Pat. No. 8,261,645, to Dale, is an example of a prior art attempt to provide an adjustable log support featuring a ratcheting, quick-adjustable, self-locking clamp. A problem with log supports like the one disclosed in U.S. '645 is that it requires the operator to use two hands to adjust; one hand to operate the handle to release ratchet teeth locking the log support in a selected vertical position, and a second hand to raise or lower the log support.

U.S. Pat. No. 9,102,074, also to Dale, is another example of a prior art attempt to provide an adjustable log support; this one featuring a rack and pinion for adjusting the vertical position of the log support. In addition to involving a relatively slow and laborious process of turning a handle until the desired vertical position is achieved, a second hand is needed to manipulate a pawl to release the handle.

Other attempts at providing vertically adjustable log supports are disclosed in U.S. Pat. Nos. 9,352,480, and 9,676,116, each demonstrating their own particular problems.

U.S. Pat. Nos. 9,593,800, 9,840,392, and 9,862,581, and U.S. Pat. App. Pub. No. 2004/0178306 disclose solutions to problems in other, unrelated fields. Though it is not readily apparent how, if at all, they may apply to log support assemblies.

Therefore, there is a continuing need for improvement in log support assemblies for sawmills.

### SUMMARY OF THE INVENTION

What is desired is a log support assembly for a sawmill that overcomes at least some of the problems with prior art log support assemblies. Preferably, the log support assembly will be a simple mechanical device, built with few parts, which is inexpensive to manufacture, and easy to operate.

According to an embodiment of the present invention, the log support assembly has an elongate log support member with at least one aperture in its side wall, a holder for releasably holding the elongate log support member, a passageway in the holder for slidably receiving the elongate log support member, and a projection extending into the passageway. The projection is sized and shaped to releasably engage the at least one aperture. The passageway is sized and shaped to allow the elongate log support member to be tilted between a locked position with the projection engaging the at least one aperture, and an unlocked position with the projection disengaged from the at least one aperture. The locked position prevents the elongate log support member to be lowered relative to the holder, while the unlocked position permits the elongate log support member to be raised or lowered relative to the holder. Preferably, the support assembly will allow a user to adjust a height of the elongate log support member with one hand.

Therefore, in accordance with one aspect of the present invention, there is disclosed a log support assembly for a sawmill having a bed configured to support a log, said log support assembly comprising:
an elongate log support member having a top, a bottom, and a side wall extending between said top and said bottom of said elongate log support member, said side wall containing at least one aperture;
a holder for releasably holding said elongate log support member with said top of said elongate log support member extending from said top of said holder;
a passageway between said top of said holder and a bottom of said holder, said passageway being sized and shaped to slidably receive at least a portion of said elongate log support member; and
a projection positioned between said top and said bottom of said holder and extending into said passageway, said projection being sized and shaped to releasably engage said at least one aperture;
wherein said passageway is sized and shaped to allow said elongate log support member to be tilted between a locked position with said projection engaging said at least one aperture, and an unlocked position with said projection disengaged from said at least one aperture;
wherein said locked position prevents said elongate log support member to be lowered relative to said holder; and
wherein said unlocked position permits said elongate log support member to be raised or lowered relative to said holder.

In accordance with another aspect of the present invention, there is disclosed a method of releasing the above noted elongate log support member from said locked position to raise or lower said elongate log support member relative to said holder, said method comprising the steps of:
with said elongate log support member in said locked position, grasping said top of said elongate log support member with one hand;
tilting said elongate log support member in said passageway away from said projection to disengage said projection from said at least one aperture; and
raising or lowering said elongate log support member relative to said holder with said one hand.

In accordance with yet another aspect of the present invention, there is disclosed a method of securing the above noted elongate log support member in said locked position to prevent said elongate log support member to be lowered relative to said holder, said method comprising the steps of:
with said elongate log support member in said unlocked position, grasping said top of said elongate log support member with one hand;
raising or lowering said elongate log support member in said unlocked position relative to said holder with said one hand; and
tilting said elongate log support member in said passageway from said unlocked position toward said locked position to engage said projection to said at least one aperture.

### BRIEF DESCRIPTION OF THE DRAWINGS

Reference will now be made to the preferred embodiments of the present invention with reference, by way of example only, to the following drawings in which:

FIG. 1 is a perspective view of a prior art portable sawmill;

FIG. 2 is a front view of the prior art sawmill of FIG. 1;

FIG. 3 is a perspective view of a log support assembly, according to an embodiment of the present invention, the log support assembly is shown attached to a log bunk of a sawmill, with an elongate log support member held in a holder in a locked position which prevents the elongate log support member to be lowered relative to the holder;

FIG. 4 is a perspective view of the log support assembly of FIG. 3, showing the elongate log support member being held in the holder in an unlocked position which permits the elongate log support member to be raised or lowered relative to the holder;

FIG. 5 is a perspective view of the log support assembly of FIG. 3, showing the elongate log support member being held in the holder in a locked position, after the top of the elongate log support member was raised from a first predetermined height above the top of the holder as shown in FIG. 3, to a second predetermined height above the top of the holder, and tilted to the locked position;

FIG. 6 is side view of FIG. 4, showing the elongate log support member in the unlocked position, prior to the top of the elongate log support member being raised from the first predetermined height above the top of the holder to the second predetermined height above the top of the holder;

FIG. 7 is a side view of FIG. 6, after the top of the elongate log support member was raised from the first predetermined height above the top of the holder to the second predetermined height above the top of the holder, and prior to being tilted from the unlocked position to the locked position;

FIG. 8 is a side view of FIG. 7. after the elongate log support member was tilted from the unlocked position to the locked position;

FIG. 9 is a top view of FIG. 4, showing the elongate log support member in the unlocked position;

FIG. 10 is a bottom view of FIG. 9;

FIG. 11 is a top view of FIG. 3, showing the elongate log support member in the locked position;

FIG. 12 is a bottom view of FIG. 12;

FIG. 13 is a front view of the elongate log support member of FIG. 3;

FIG. 14 is a left side view of the elongate log support member of FIG. 13:

FIG. 15 is a rear view of the elongate log support member of FIG. 13;

FIG. 16 is a right side view of the elongate log support member of FIG. 13;

FIG. 17 is a top view of the elongate log support member of FIG. 13;

FIG. 18 is a bottom view of the elongate log support member of FIG. 13;

FIG. 19 is a front view of the holder of FIG. 3;

FIG. 20 is a left side view of the holder of FIG. 19;

FIG. 21 is a rear view of the holder of FIG. 19;

FIG. 22 is a right side view of the holder of FIG. 19;

FIG. 23 is a top view of the holder of FIG. 19;

FIG. 24 is a bottom view of the holder of FIG. 19;

FIG. 25 is a cross-sectional view of FIG. 3 taken along line 25-25; and

FIG. 26 is a front view of FIG. 25 taken along line 26-26; and

FIG. 27 is a front view of an elongate log support member according to another embodiment of the present invention.

### DETAILED DESCRIPTION OF THE PREFERRED EMBODIMENTS

The present invention is described in more detail with reference to exemplary embodiments thereof as shown in the appended drawings. While the present invention is described below including preferred embodiments, it should be understood that the present invention is not limited thereto. Those of ordinary skill in the art having access to the teachings herein will recognize additional implementations, modifications, and embodiments which are within the scope of the present invention as disclosed and claimed herein. In the figures, like elements are given like reference numbers. For the purposes of clarity, not every component is labelled in every figure, nor is every component of each embodiment of the invention shown where illustration is not necessary to allow those of ordinary skill in the art to understand the invention. Orientative words such as, for example, “top”, “bottom”, “front”, and “side” as used herein are used for clarity with reference to the orientation of elements in the figures and are not intended to be limiting.

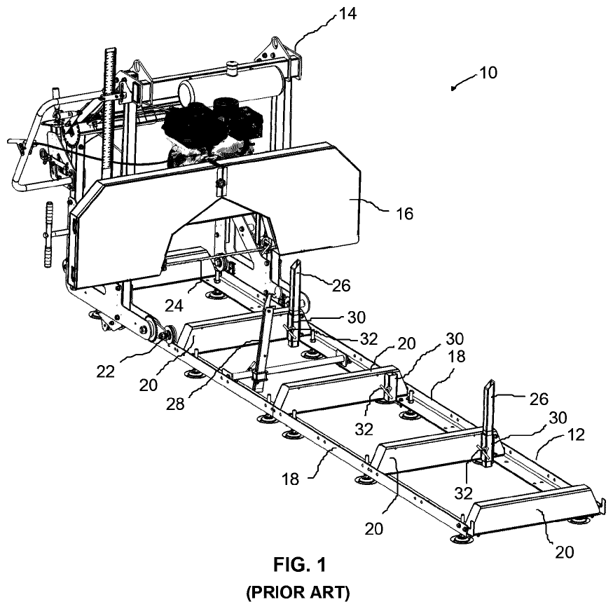

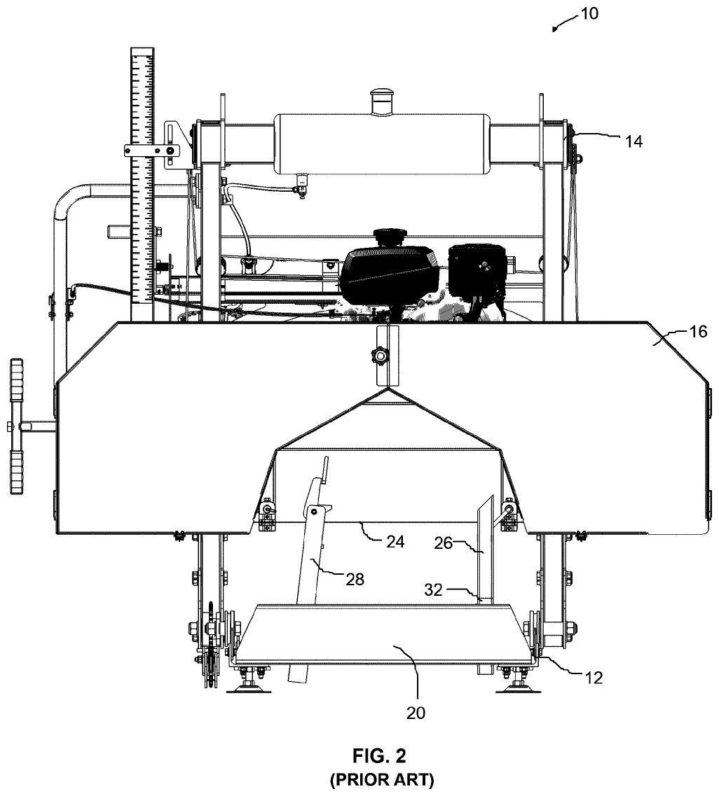

FIGS. 1 and 2 respectively show a perspective view and front view of a prior art portable sawmill 10. As can be seen, the portable sawmill has a bed 12 for supporting a log (not shown), and a carriage 14 for carrying a saw 16, such as for example a band saw. The bed 12 includes a pair of parallel rails 18, and several log bunks 20 arranged between the rails 18, for supporting the log. The carriage 14 is movable along the rails 18 on wheels 22. With the saw 16 operating, moving the carriage 14 along the rails 18 over the log allows a saw blade 24 of the saw 16 to cut the log.

The bed 12 shown in FIGS. 1 and 2 includes a prior art log support system for holding a log in position on the bed 12 to keep it from moving as the log is being cut with the saw 16. The prior art log support system includes log supports 26, and log dogs 28. As is known in the art, the system allows a user to clamp the log in place on the bed 12 between the log supports 26 and the log dogs 28. The log supports 26 function as the back-stop against which the log dogs 28 exert force. thereby clamping the log.

The log supports 26 are held in conventional holders 30, attached to log bunks 20. The conventional holders 30 are simple sleeves, square shaped in cross section, sized slightly larger than the log supports 26 they are designed to hold. Each log support 26 is secured in position in its respective conventional holder 30 with a T-bolt screw 32. The T-bolt screw 32 needs to be loosened to allow the operator to raise or lower the height of the log support 26, and tightened to secure the log support 26 in the conventional holder 30 at the desired height. Thus, an operator manipulates the T-bolt screw 32 with one hand, and raises or lowers the log support 26 relative to the conventional holder 30 with his or her other hand.

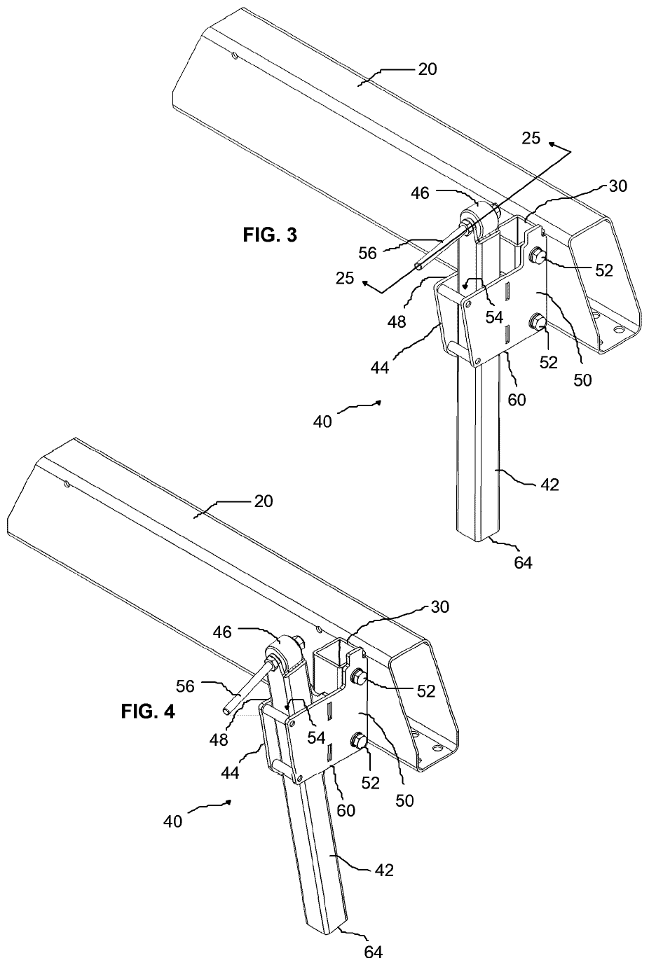

Referring now to FIG. 3, there is shown a log support assembly 40 according to an embodiment of the present invention. Preferably, the log support assembly 40 may be attached to the bed 12 of a portable sawmill 10. Most preferably, the log support assembly 40 may be attached to a log bunk 20, as shown.

The log support assembly 40 has an elongate support member 42, which is releasably held in a holder 44, with the top 46 of the elongate support member 42 extending from the top 48 of the holder 44. As will be discussed in more detail below. the elongate support member 42 and the holder 44 are configured to cooperate to allow the top 46 of the elongate log support member 42 to be raised or lowered relative to the top 48 of the holder 44. Furthermore, the elongate support member 42 may be held in place in a locked position with its top 46 at one of several preselected heights above the top 48 of the holder 44.

Preferably, the log support assembly 40 includes a means of attaching the holder 44 to the bed 12 of the portable sawmill 10. By way of example, the means of attachment may include a flange 50 extending from the holder 44, which is configured for attaching the holder 44 to a log bunk 20.

According to one embodiment of the present invention, the log support assembly 40 may be configured for attachment to an existing conventional holder 30, as shown in FIGS. 3 to 5. In such retrofit applications, the flange 50 may be further configured to mount to the existing conventional holder 30 with fasteners 52. including threaded fasteners such as bolts and nuts. However, it is also contemplated that in other embodiments, the flange 50 may be configured for attachment to an existing conventional holder 30, a log bunk 20, or even another element of the bed 12, by other known ways depending on the specific application, including for example by welding. All such embodiments are comprehended by the present inventions.

Preferably, the holder 44 defines a passageway 54 for slidably receiving the elongate log support member 42, when the elongate log support member 42 is in an unlocked position (shown in FIGS. 4, 6, and 7). Furthermore, the passageway 54 is sized and shaped to allow the elongate log support member 42 to be tilted between the unlocked position and a locked position (shown in FIGS. 3, 5, and 8). The locked position (i.e. FIG. 3), prevents the elongate log support member 42 to be lowered relative to the holder 44, while the unlocked position (i.e. FIG. 4) permits the elongate log support member 42 to be raised or lowered relative to the holder 44.

Preferably, the log support assembly 40 may be configured to allow the operator to adjust the height of the elongate log support member 42 with one hand, as demonstrated by the example shown in FIGS. 3 to 5.

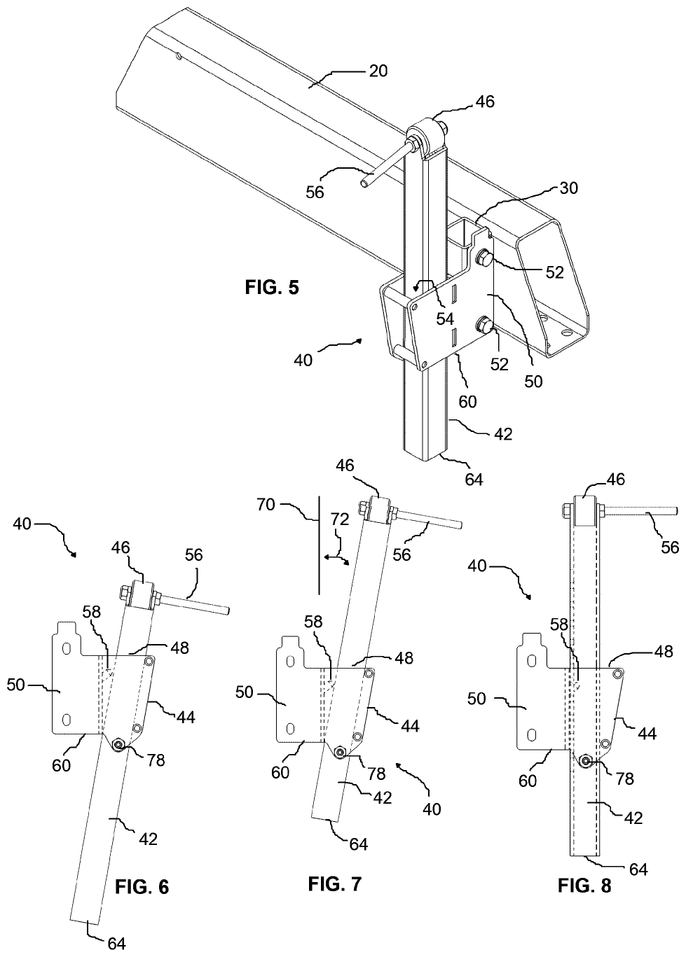

Beginning with FIG. 5, the log support member 42 is shown in a locked position with its top 46 at a lowermost height above the top 48 of the holder 44. To raise the elongate log support member 42, the operator will grasp the elongate log support member 42 with one hand to manipulate the log support member 42 into the unlocked position shown in FIG. 4. The elongate log support member 42 may be manipulated with one hand from the locked position (i.e. FIG. 3), to the unlocked position (i.e. FIG. 4), by simultaneously lifting and tilting the elongate log support member 42. As will be made more clear later when the locking mechanism is described, a slight upward force is needed to break the lock holding the elongate log support member 42 in place, before it can be tilted to the unlocked position shown in FIG. 4. Once in the unlocked position, the operator can raise the elongate log support member 42 to a desired height by pulling on the tilted elongate log support member 42. At that point, the operator can manipulate the elongate log support member 42 back to the locked position with its top 46 now at a raised height above the top 48 of the holder 44, as shown, for example, in FIG. 5. The elongate log support member 42 may be manipulated with one hand from the unlocked position, back to the locked position (i.e. FIG. 5), by tilting the elongate log support member 42. As will be made more clear later when the locking mechanism is described, a slight downward force may be needed to lock the elongate log support member 42 in place, for example, by pushing the elongate log support member 42 downwardly into the holder 44. Although, the weight of the elongate log support member 42 may be sufficient.

The above-described steps for raising the elongate log support member 42 are also shown with the sequence of side views depicted in FIGS. 6 to 8. In particular, FIG. 6 shows a side view of the log support assembly 40, with the elongate log support member 42 in the unlocked position, prior to the top 46 of the elongate log support member 42 being raised from a first predetermined height above the top 48 of the holder 44 to a second predetermined height above the top 48 of the holder 44. Next, FIG. 7 shows a side view of the log support assembly 40 after the top 46 of the elongate log support member 42 was raised from the first predetermined height above the top 48 of the holder 44 to the second predetermined height above the top 48 of the holder 44, and prior to the elongate log support member 42 being tilted from the unlocked position to the locked position. Finally, FIG. 8 shows a side view of log support assembly 40 after the elongate log support member 42 was tilted from the unlocked position to the locked position.

Having described above steps for raising the elongate log support member 42. according to an embodiment of the present invention, it will be appreciated that lowering of the elongate log support member 42 may be accomplished by simply reversing the above-described steps.

Preferably, a handle 56 may be attached proximate to the top 46 of the elongate log support member 42 for the operator to grasp to facilitate lifting, tilting, raising and lowering of the elongate log support member 42.

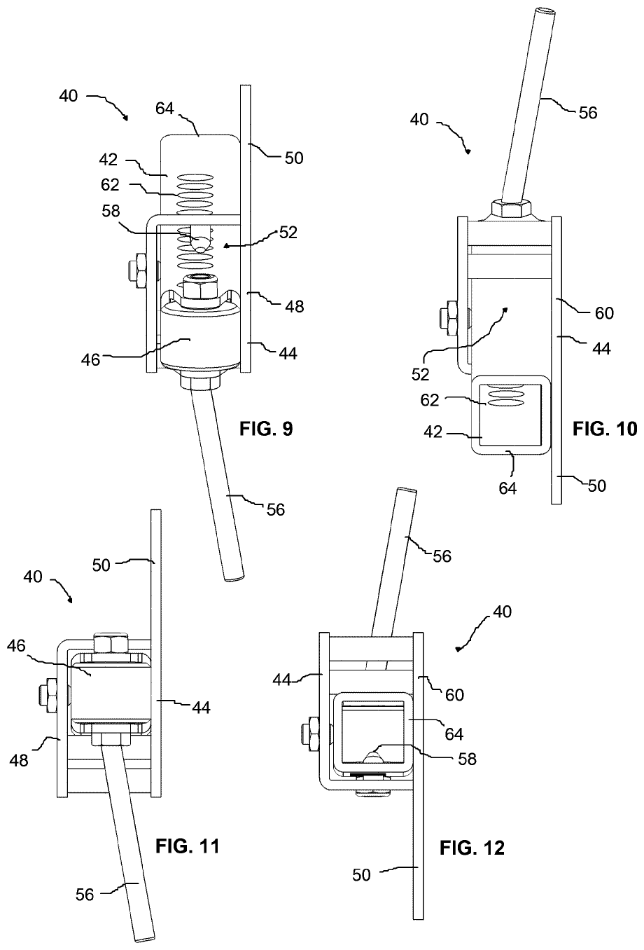

Referring now to FIGS. 9 and 10, there are shown respective top and bottom views of the preferred log support assembly 40 with the elongate log support member 42 in the unlocked position. The top 46 of the elongate log support member 42 extends above the top 48 of the holder 44, and the bottom 64 of the elongate log support member 42 extends below the bottom 60 of the holder 44. As best seen in FIG. 9, a projection 58 is preferably positioned between the top 48 and the bottom 60 of the holder 44 and extending into the passageway 54. The projection 58 is sized and shaped to releasably engage at least one aperture 62 on the elongate log support member 42.

FIGS. 11 and 12 show respective top and bottom views of the log support assembly 40 with the elongate log support member 42 in the locked position. As best seen in FIG. 12, when the elongate log support member 42 is in the locked position, the projection 58 releasably engages the at least one aperture 62. Thus, it will now be appreciated that the passageway 54 is preferably sized and shaped to allow the elongate log support member 42 to be tilted between the locked position with the projection 58 engaging the at least one aperture 62, and an unlocked position with the projection 58 disengaged from the at least one aperture 62.

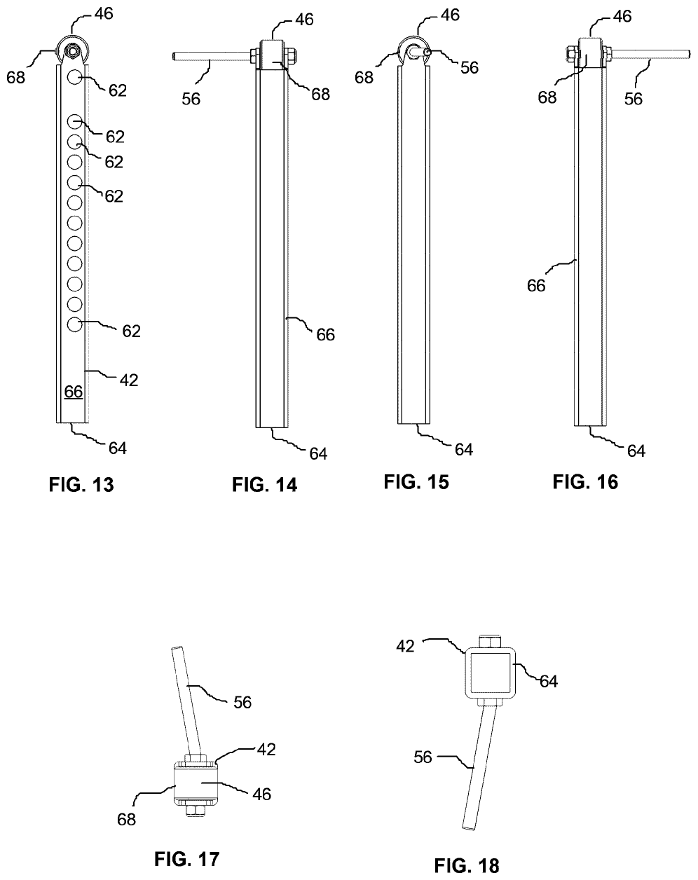

Referring now to FIGS. 13 to 18, a preferred embodiment of the elongate log support member 42 will now be described in more detail. As can be seen with reference to FIGS. 13 and 18, the elongate log support member 42 may preferably be formed as an elongate, hollow member, with a rectangular, preferably square, cross-section. Preferably, the elongate log support member may be made from metal, such as steel, most preferably mild steel.

Referring now to FIG. 13, the front of the elongate log support member 42 has a side wall 66 extending between its top 46 and bottom 64. Advantageously, the top 46 of the elongate log support 42 may be provided with a handle 56, as mentioned above, and also a roller 68 to facilitate rolling a log on the bed 12 if desired. The side wall 66 contains at least one aperture 62 configured to engage the projection 58, as mentioned above. Preferably, however, the elongate log support member 42 may comprise two or more of the at least one aperture 62 to allow the top 46 of the elongate log support member 42 to be selectively locked in positions at two or more predetermined heights above the top 48 of the holder 44. Most preferably, a plurality of the at least one aperture 62 may be provided in the side wall 66 of the elongate log support member 42 in a spaced apart arrangement. In such cases, at least some, or all of the plurality of apertures 62 may preferably be spaced apart by an equal distance, such as for example one inch. Preferably, the apertures 62 may be round, and having a diameter in a range of about 15 mm to about 20 mm. In this regard, it is noted that good results have been obtained with an elongate log support member 42 measuring 48 cm from top 46 to bottom 64, and having a width and a depth of 4 cm, with its side wall 66 containing apertures 62 having diameters measuring 18 mm, for engaging a cylindrical projection 58 having a diameter measuring 10 mm, as discussed below. What is important is to ensure that the aperture 62 is large enough to fit over the cylindrical projection 58 when the aperture 62 is at an angle at the point of engagement with the cylindrical projection 58.

Although the elongate log support member 42 shown in FIG. 13 shows twelve such apertures 66 contained in its side wall 66, more or fewer apertures 66 may be provided in its side wall 66 in other embodiments of the present invention. All such embodiments are comprehended by the present invention.

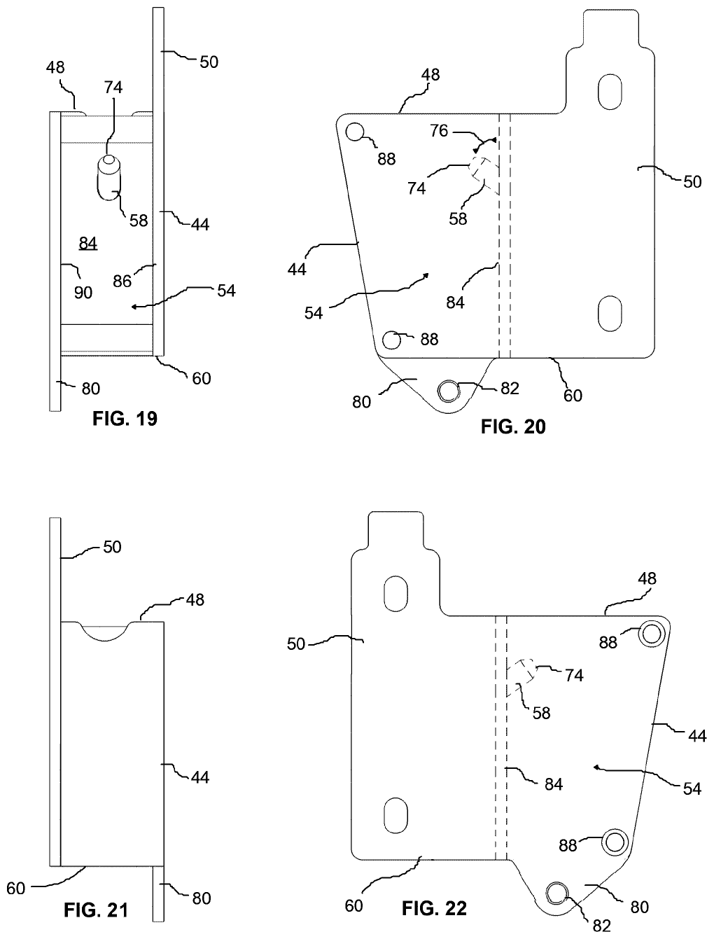

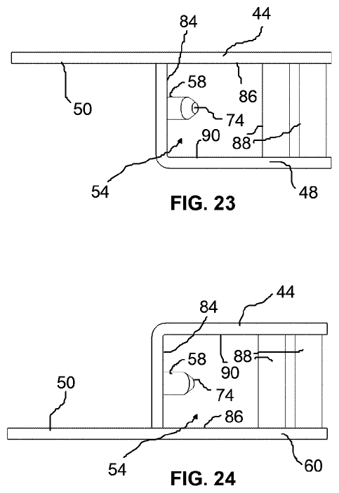

Referring now to FIGS. 19 to 24, a preferred embodiment of the holder 44 will now be described in more detail. As can be seen with reference to FIGS. 19, 20, and 22, which respectively show front, left side, and right side views of the holder 44, there is a passageway 54 formed between the top 48 and bottom 60 of the holder 44, and the passageway 54 contains the projection 58. As mentioned above, the projection 58 is positioned between the top 48 and the bottom 60 of the holder 44 and extends into the passageway 54. Furthermore, the passageway 54 is wider at the top 48 of the holder 44 than the bottom 60 of the holder 44, to allow the elongate log support member 42 to be slidably received therein, and to be tilted toward and away from the projection 58 between the locked and unlocked positions. Preferably, the holder 44 may be made from metal, such as steel, most preferably mild steel.

Referring briefly back to FIGS. 7 and 8, the passageway 54 is preferably shaped such that when the elongate log support member 42 is in the locked position, for example as shown in FIG. 8, the elongate log support member 42 extends from the holder 44 at a first angle 70 substantially perpendicular to the bed 12, and when the elongate log support member 42 is tilted to the unlocked position, for example as shown in FIG. 7, the elongate log support member 42 extends from the holder 44 at a tilt angle 72 relative to the first angle 70. Good results have been obtained by configuring the passageway 54 to provide for a tilt angle 72 (see FIG. 7) of about 10°. However, the tilt angle 72 may be more or less in other embodiments. For example, a suitable tilt angle 72 may be in a range of about 5 of 10° to about 15 of 10°. All such embodiments are comprehended by the present invention.

Preferably, the projection 58 may be cylindrical in cross-section. In particular, good results were obtained with a cylindrical projection having a length of 2.5 cm, and diameter of about 10 mm, for engaging round apertures 62 having diameters of about 18 mm. However, it will be appreciated that other embodiments may be designed with projections 58 and apertures 62 having other diameters. All such embodiments are comprehended by the present invention. What is important is that the projections 58 and apertures 62 are sized and shaped to cooperate to allow the elongate log support member 42 to be tilted in the holder 44 between the locked and unlocked positions, as described above. Preferably, the projection 58 may be provided with a tapered end 74 to facilitate engagement with the apertures 62. Good results have been obtained by providing the projection 58 with a length in a range of about 2 to 3 cm.

As best seen in FIGS. 19, 20, and 22, the projection 58 is preferably angled upwardly toward the top 48 of the holder 44. Good results have been obtained by providing the projection 58 at an angle 76 (see FIG. 20) of about 55°. However, the projection angle 76 may be more or less in other embodiments. For example, a suitable projection angle 76 may be in a range of about 45 degrees to about 65 degrees. All such embodiments are comprehended by the present invention. What is desired is that the angle 76 will provide the projection 58 with a rise that is sufficiently steep to allow gravity to provide enough of a downward force on the elongate log support member 42 to seat the aperture 62 on the projection 58, thereby securing the elongate log support member 42 within the holder 44 in the locked position.

Referring now to FIGS. 6 to 12, a set screw 78 is shown in a flange 80 extending from the bottom 60 of the holder 44 on the right side of the holder 44. The flange 80 contains a threaded bore 82, in which the threaded set screw 78 is secured. Preferably, the set screw 78 may be made from stainless steel. The set screw 78 is configured to tune the tolerance between the holder 44 and the elongate log support member 42.

For example, if the holder 44 is provided with a passageway 54 having a width of 4.2 cm, the outside width of the elongate log support member 42 may be chosen to be 4.0 cm. This is due to the fact that although a 4.0 cm width may be desired, limitations in the manufacturing process may result in the actual widths varying between 3.9 cm and 4.1 cm, for example. Similarly, there is also the possibility of variability in the width of the passageway 54, due to manufacturing constraints. Thus, an extra space is designed into the log support assembly 40 in order to facilitate free movement of the elongate log support member 42 within the passageway 54 of the holder 44, when the elongate log support member 42 is in the unlocked position, even if the outside width of the elongate log support member 42 is larger in some cases. However, the extra space could cause the elongate log support member 42 to rattle in the holder 44. For this reason, the set screw 78 may be provided to reduce the size of the gap, reduce the rattling when the elongate log support member 42 is manufactured with an outside width that is slightly less than the design width. It should be noted that the set screw 78 may be omitted in other embodiments of the present invention.

Referring now to the embodiment of the holder 44 shown in FIGS. 19 to 24, it can be seen that the passageway 54 is defined by a first bearing surface 84 configured to carry the projection 58, a second bearing surface 86 positioned adjacent to the first bearing surface 84 to face the log, a first containing surface 88 positioned opposite the first bearing surface 84, and a second containing surface 90 opposite the second bearing surface 86. Preferably, the first and second bearing surfaces 84, 86 are configured to support the elongate log support member 42 when in the locked position and a lateral force is applied to the elongate log support member by the log. In contrast, the first and second containing surfaces 88, 90 are configured to help keep the elongate log support member contained within the passageway 54. The first bearing surface 84, the second bearing surface 86, and the second containing surface 90 are preferably made from metal plates, such as for example steel. Most preferably, the metal plates are made from mild steel. The first and second bearing surfaces 84, 86 will preferably be sufficiently robust to withstand loads exerted on them by the elongate log support member 42, when in use in the locked position, and supporting a log. In this regard, good results have been obtained by fabricating the holder 44 from standard mild grade steel having a thickness of about 4 mm.

Although the first containing surface 88 may also be made from one or more metal plates, good results have been obtained by providing the first containing surface 88 in the form of a pair of elongate spacers 92 positioned between the second containing surface 90 and the second bearing surface 86. Preferably the spacers 92 may be cylindrical shaped, and spaced apart, with one spacer 92 being positioned proximate to the top 48 of the holder 44, and the other spacer 92 being positioned proximate to the bottom 60 of the holder 44. In this way, the first containing surface 88 may be provided as a discontinuous surface. However, as mentioned above, the first containing surface 88 may also be presented as a metal plate to provide a continuous surface. Similarly, one or more of the first bearing surface 84, the second bearing surface 86, and the second containing surface 90 may be provided as a discontinuous surface. All such embodiments are comprehended by the present invention.

Advantageously, it has been found that providing the first containing surface 88 in the form of the pair of elongate spacers 92, as opposed to a metal plate to provide a continuous surface, allowed debris, such as bark and sawdust to fall out of the passageway 54 of holder 44 to the ground rather than being trapped in the passageway 54.

Preferably, the first bearing surface 84, the second bearing surface 86, and the first containing surface 88 are configured to be substantially vertical when the log support assembly 40 is in use. In contrast, the first containing surface 88 is preferably configured to be at an angle relative to the first bearing surface 84 when the log support assembly 40 is in use. Preferably, the angle is sufficient to provide a tilt angle 72 in a range of about 5° to about 15° for the elongate log support member 42 as mentioned above. Accordingly, the angle between the first containing surface 88 and the first bearing surface 84 will preferably be in a range of about 5° to about 15° also. Most preferably the angle between the first containing surface 88 and the first bearing surface 84 will be 10 about 5° to about 10°.

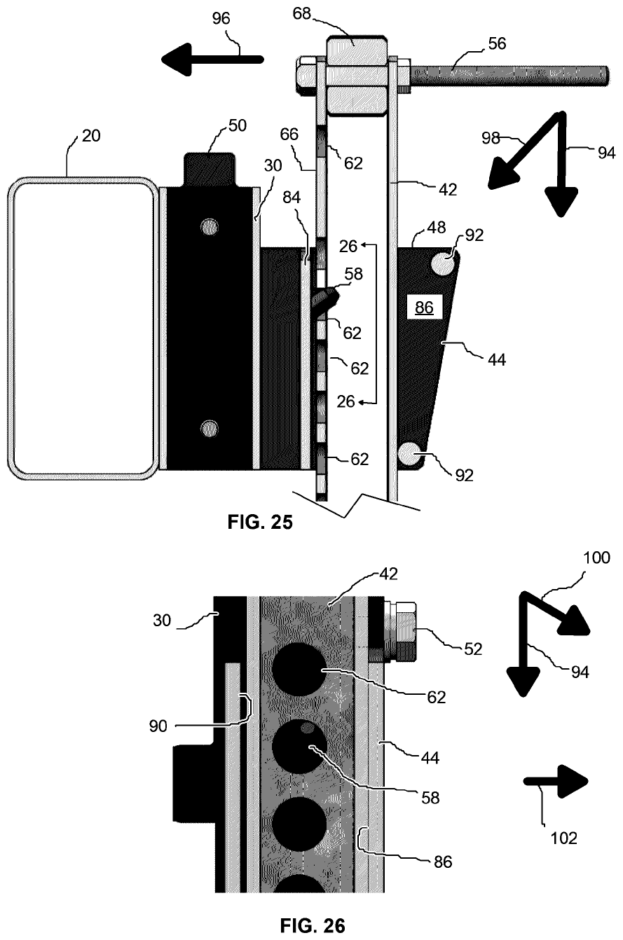

Referring now to FIG. 25, the log support assembly 40 is shown mounted to an existing holder 30 attached to a log bunk 20. The log support assembly 40 is mounted to the existing holder 30 via flange 50. The elongate log support member 42 is held in the holder 44 in the locked position, with the projection 58 engaging one of several apertures 62 provided in the side wall 66 of the elongate log support member 42. As previously mentioned, the projection 58 carried by the first bearing surface 84, is preferably angled upwardly toward the top 48 of the holder 44. Furthermore, the angle 76 of the projection 58 is preferably selected to help wedge the elongate log support member 42 against the first bearing surface 84 when the elongate log support member 42 is tilted to the locked position. Good results have been obtained by providing the projection 58 with an angle 76 of about 55°. However, other angles may provide desirable results in other embodiments. When such a wedging action is desired, what is important is that the upward angle 76 of the projection 58 redistributes a portion of the downward force 94 applied to the elongate log support member 42 in a lateral direction 96 toward the first bearing surface 84. In other words, the downward force 94 is redirected by the angled projection 58 along arrow 98, parallel to the projection 58, thereby redistributing a component of the downward force 94 in the lateral direction 96. Furthermore, a portion of the side wall 66 is wedged in the hook formed between the projection 58 and the first bearing surface 84.

Advantageously, embodiments of the present invention utilizing the above noted wedging action for securing the elongate log support member 42 into the locked position, allow for simpler manufacturing of the log support assembly 40, as compared with prior art methods, which utilize gears for example. Furthermore, embodiments of the log support assembly 42 according to the present invention require lower or no servicing due to their simple design and reduced parts count, and they avoid the need for a secondary motion for operation by a user, such as cranking a handle.

Preferably, a second wedge may be formed between the projection 58 and the second bearing surface 86 as shown in FIG. 26. In this example, the apertures 62 are laterally offset relative to the projection 58. In particular, the projection 58 is centered between the second bearing surface 86 and the second containing surface 90 of the holder, but the apertures 62 contained in the side wall 66 of the elongate log support member 42 are not centered. Instead, the apertures 62 are arranged so that when the elongate log support member 42 is in the holder 44, the apertures 62 are closer to the second containing surface 90. In this way, when the aperture 62 is engaged by the projection 58 as the elongate log support member is tilted to the locked position, and a downward force 94 is applied on the elongate log support member 42, the elongate log support member 42 will wedge against the second bearing surface 86. Good results have been obtained by providing an offset between the projection 58 and the apertures 62 of 2.65 mm, when using a 10 mm diameter projection 58 and 18 mm diameter apertures 62. However, other offsets may also provide desirable results in other embodiments. Depending on the size of the projection 58 and aperture 62 used in a particular log support assembly 40, the offset may be in a range of 2 mm to 5 mm, for example. When such a wedging action is desired, what is important is that the offset of the apertures 62 redistributes a portion of the downward force 94 applied to the elongate log support member 42 in a lateral direction 102 toward the second bearing surface 86. In other words, the downward force 94 is redirected by the round portion of the aperture 62 bearing against the projection 58 at an angle along arrow 100, thereby redistributing a component of the downward force 94 in the lateral direction 100. Furthermore, a portion of the side wall 66 is preferably wedged in the space formed between the projection 58 and the second bearing surface 86. All such embodiments of the present invention are comprehended by the present invention.

It is worth noting that although the embodiment shown in FIG. 26, has the projection 58 centered between the second bearing surface 86 and the second containing surface 90 of the holder 44, this need not be the case. For example, the offset mentioned above may be formed by positioning the projection 58 closer to the second bearing surface 86, and instead centering the apertures 62. Moreover, neither the projection 58 nor the apertures 62 need to be centered. What is desired is that the relative positions of the projection 58 and the apertures 62 are such that when a downward force 94 is applied to the elongate log support member 42, the projection 58 interacts with the aperture 62 to force the elongate log support member 42 towards the second bearing surface 86 in lateral direction 102. Furthermore, a portion of the side wall 66 is preferably wedged in the space formed between the projection 58 and the second bearing surface 86. All such embodiments of the present invention are comprehended by the present invention.

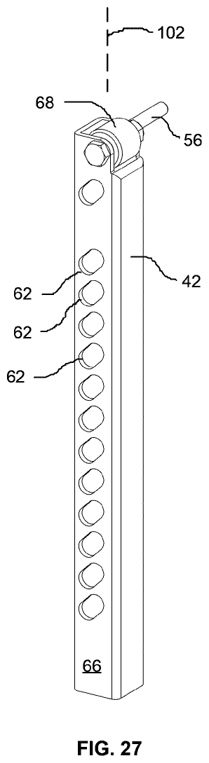

Referring now to FIG. 27, there is shown an elongate log support member 42 according to another embodiment of the present invention. In this example, the side wall 66 of the elongate log support member 42 contains a plurality of apertures 62 which are shaped like slots. In other words, the apertures 62 are not round, as previously discussed, but elongated. The slot shaped apertures may be rounded like ovals, or unrounded like rectangles. Furthermore, the slot shaped apertures 62, may be angled relative to a longitudinal axis 102 of the elongate log support member 42 to help wedge the elongate log support member 42 against the second bearing surface 86 when the elongate log support member 42 is tilted to the locked position.

While reference has been made to various preferred embodiments of the invention other variations, implementations, modifications, alterations and embodiments are comprehended by the broad scope of the appended claims. Some of these have been discussed in detail in this specification and others will be apparent to those skilled in the art. Those of ordinary skill in the art having access to the teachings herein will recognize these additional variations, implementations, modifications, alterations and embodiments, all of which are within the scope of the present invention, which invention is limited only by the appended claims.

The embodiments of the invention in which an exclusive property or privilege is claimed are defined as follows:

1. A log support assembly for a sawmill having a bed configured to support a log, said log support assembly comprising:
an elongate log support member having a top, a bottom, and a side wall extending between said top and said bottom of said elongate log support member, said side wall containing at least one aperture;
a holder for releasably holding said elongate log support member with said top of said elongate log support member extending from said top of said holder;
a passageway between said top of said holder and a bottom of said holder, said passageway being sized and shaped to slidably receive at least a portion of said elongate log support member; and
a projection positioned between said top and said bottom of said holder and extending into said passageway, said projection being sized and shaped to releasably engage said at least one aperture;
wherein said passageway is sized and shaped to allow said elongate log support member to be tilted between a locked position with said projection engaging said at least one aperture, and an unlocked position with said projection disengaged from said at least one aperture;
wherein said locked position prevents said elongate log support member to be lowered relative to said holder; and
wherein said unlocked position permits said elongate log support member to be raised or lowered relative to said holder.

2. The log support assembly as claimed in claim 1, wherein said elongate log support member comprises two or more of said at least one aperture to allow said top of said elongate log support member to be selectively locked in positions at two or more predetermined heights above a top of said holder.

3. The log support assembly as claimed in claim 1, wherein said passageway is wider at said top of said holder than said bottom of said holder, to allow said elongate log support member to be tilted toward and away from said projection between said locked and unlocked positions.

4. The log support assembly as claimed in claim 3, wherein said passageway is shaped such that when said elongate log support member is in said locked position said elongate log support member extends from said holder at a first angle substantially perpendicular to said bed; and
wherein when said elongate log support member is in said unlocked position said elongate log support member extends from said holder at a tilt angle relative to said first angle.

5. The log support assembly as claimed in claim 4, wherein said tilt angle is in a range of about 5° to about 15° relative to said first angle.

6. The log support assembly as claimed in claim 3, wherein said passageway is defined by a first bearing surface configured to carry said projection, a second bearing surface positioned adjacent said first bearing surface to face said log, a first containing surface positioned opposite said first bearing surface, and a second containing surface opposite said second bearing surface;
wherein said first and second bearing surfaces are configured to support said elongate log support member when in said locked position and a lateral force is applied to said elongate log support member by said log; and
wherein said first and second containing surfaces are configured to help keep said elongate log support member contained within said passageway.

7. The log support assembly as claimed in claim 6, wherein said first bearing surface, said second bearing surface, and said first containing surface are configured to be substantially vertical when said log support assembly is in use.

8. The log support assembly as claimed in claim 7, wherein said first containing surface is configured to be at an angle relative to said first bearing surface.

9. The log support assembly as claimed in claim 8, wherein said angle is in a range of about 5° to about 15° relative to said first bearing surface.

10. The log support assembly as claimed in claim 6, wherein said projection is angled upwardly toward said top of said holder; and
wherein said angle is selected to help wedge said elongate log support member against said first bearing surface when said elongate log support member is tilted to said locked position.

11. The log support assembly as claimed in claim 6, wherein at least one of said first bearing surface, said second bearing surface, said first containing surface, and said second containing surface is discontinuous.

12. The log support assembly as claimed in claim 11, wherein said first containing surface is discontinuous.

13. The log support assembly as claimed in claim 12, wherein said first containing surface comprises a pair of spaced apart elongate spacers positioned between said second containing surface and said second bearing surface.

14. The log support assembly as claimed in claim 6, wherein said at least one aperture is offset laterally relative to said projection to force said elongate log support member against said second bearing surface when said elongate log support member is tilted to said locked position.

15. The log support assembly as claimed in claim 1, further comprising a flange extending from said holder, said flange being configured for attaching said holder to said bed.

16. The log support assembly as claimed in claim 15, wherein said flange is configured to mount to an existing log support holder in a retrofit application.

17. The log support assembly as claimed in claim 1, wherein said log support has a rectangular cross-section.

18. The log support assembly as claimed in claim 1, comprising a plurality of said at least one aperture in a spaced apart arrangement.

19. The log support assembly as claimed in claim 18, wherein said plurality of apertures are spaced apart by an equal distance.

20. The log support assembly as claimed in claim 1, wherein said elongate log support member further comprises a handle attached proximate to said top of said elongate log support member.

21. The log support assembly as claimed in claim 1, wherein said projection is cylindrical in cross-section.

22. The log support assembly as claimed in claim 1, wherein said cylinder has a diameter of about 10 mm.

23. The log support assembly as claimed in claim 1, wherein said projection has a tapered end.

24. The log support assembly as claimed in claim 1, wherein said projection is angled upwardly toward said top of said holder.

25. The log support assembly as claimed in claim 24, wherein said angle is in a range of about 45° degrees to about 65°.

26. The log support assembly as claimed in claim 25, wherein said angle is 55°.

27. The log support assembly as claimed in claim 1, wherein said apertures are round.

28. The log support assembly as claimed in claim 26, wherein said round apertures have diameters in a range of about 15 mm to about 20 mm.

29. The log support assembly as claimed in claim 1, wherein said elongate log support member further comprises a roller attached to said top of said elongate log support member.

30. The log support assembly as claimed in claim 1, wherein said elongate log support member is made from steel.

31. The log support assembly as claimed in claim 1, wherein said holder is made from steel.

32. The log support assembly as claimed in claim 1, wherein said at least one aperture is a slot.

33. The log support assembly as claimed in claim 32, wherein said slot is angled relative to a longitudinal axis of said elongate log support member to help wedge said elongate log support member against said second bearing surface when said elongate log support member is tilted to said locked position.

34. A method of releasing said elongate log support member of claim 1 from said locked position to raise or lower said elongate log support member relative to said holder, said method comprising the steps of:
with said elongate log support member in said locked position, grasping said top of said elongate log support member with one hand;
tilting said elongate log support member in said passageway away from said projection to disengage said projection from said at least one aperture; and
raising or lowering said elongate log support member relative to said holder with said one hand.

35. A method of securing said elongate log support member of claim 1 in said locked position to prevent said elongate log support member to be lowered relative to said holder, said method comprising the steps of:
with said elongate log support member in said unlocked position, grasping said top of said elongate log support member with one hand;
raising or lowering said elongate log support member in said unlocked position relative to said holder with said one hand; and
tilting said elongate log support member in said passageway from said unlocked position toward said locked position to engage said projection to said at least one aperture.

36. The method of securing said elongate log support member of claim 34, further comprising the step of:
pushing said elongate log support member downwardly into said holder with said one hand to wedge said projection into said at least one aperture.
